(19) United States
(12) Patent Application Publication
(10) Pub. No.: US 2017/0135354 A1
(43) Pub. Date: May 18, 2017

(54) Excellent Pizza Recipe

(71) Applicants: William G. Weiner, JR., Bethlehem, PA (US); Sharon Weiner, Bethlehem, PA (US)

(72) Inventors: William G. Weiner, JR., Bethlehem, PA (US); Sharon Weiner, Bethlehem, PA (US)

(21) Appl. No.: 14/942,333

(22) Filed: Nov. 16, 2015

(51) Int. Cl. A21D 13/00; A23C 19/068

(52) U.S. Cl. CPC A21D 13/007; A23C 19/0684; A23C 19/0688; A23L 1/2128; A23V 2002/00

(57) ABSTRACT

A flour and cheese based food product, which is appealing to the olfactory, and taste senses and have good nutritional value. The food product is a pizza comprises a baked dough base, which is dressed by cheese, toppings, sauce, condiments etc. wherein a unique set of ingredients impart a distinct flavor to the food product. Present invention also provides a method to prepare the above food product.

### CROSS REFERENCE TO RELATED APPLICATION

Not Applicable

### FEDERALLY SPONSORED RESEARCH AND DEVELOPMENT

Not Applicable

### MICROFICHE APPENDIX

Not Applicable

### BACKGROUND OF THE INVENTION

(1) Field of the Invention

The present invention generally relates to a novel and advantageous food product and the method to prepare the food product, more particularly, the invention relates to a pizza product and method to prepare the pizza product.

(2) Background of Invention

Pizza is an Italian recipe and has become a popular dish throughout the world. Pizza is typically a baked flatbread topped with sauces, vegetables, meat, and/or cheeses. Since, invented the pizza recipe has been modified in numerous ways including a different combinations of toppings to provide new varieties of pizza recipe. Pizza is generally sold fresh or frozen that could be heated before consumption. Besides several types of pizza known in prior art, a need is still appreciated for a new variety of pizza having a unique set of ingredients which imparts a distinct flavor to the pizza and thus having a commercial advantage.

### SUMMARY OF THE INVENTION

The present invention, therefore, has as its principal object to provide novel and advantageous food product.

An additional object of the present invention is to provide a method of preparing the food product.

A further object of the present invention is that the food product is appealing to olfactory and taste senses.

Another object of the present invention is that the food product has a nutritional value.

Yet another object of present invention is the food product has a commercial advantage. Certain embodiments of present invention provide a novel and advantageous pizza recipe, which comprise a unique set of ingredients and a method to prepare the recipe. The pizza recipe is advantageous by using a combination of four cheeses i.e. whole milk Mozzarella cheese, Provolone Dolce cheese, Argentine Sardo cheese, and Pecorino Romano cheese, which provides a distinguished taste, and improved texture to the obtained pizza product. Furthermore, the recipe comprises improved steps in preparing the pizza product, comprising twice-baking stages, and improved step of preparation of the dough.

In one embodiment, the present invention provides an improved method of adding a combination of cheeses wherein one or more cheese is hard to melt then the other cheeses in the combination. The method comprising adding the hard to melt cheeses in grated form to the prepared dough base and the dough base with grated cheese is heated. Thereafter, adding the remaining cheeses to the obtained semi-baked pizza and again heating to melt the cheeses obtaining the pizza product.

In another embodiment, the method of preparing the pizza product comprises the steps of preparing the dough, steps of leavening the dough, steps to prepare the dough base, steps to prepare the sauces, steps of adding the cheeses, steps to prepare and adding the topping and steps to bake the pizza product.

In another embodiment, the steps of preparing the dough and leavening the dough comprises the use of all-purpose flour, edible salt, fats, leavening agent such as yeast, and water.

Preferably, the step of preparing the dough comprises warming the water to predetermined temperature range, then adding the predetermined amount of yeast while mixing and the mixture is allow to stand for some predetermined duration. Thereafter, adding the predetermined amount of the all-purpose flour followed by edible salt and olive oil, which are mix to get the dough. The dough is then leaven for predetermined amount of time and the leavened dough could be used directly or stored for later use in refrigerator.

In another embodiment, the sauces are prepared by mixing the tomato puree and the crushed tomatoes, and the mixture could be stored. The sauce could be spread on the pizza base.

In another embodiment, the pizza could be prepared in two baking stages, wherein the hard to melt cheeses Argentine Sardo cheese and Pecorino Romano cheese are added in grated form to the pizza base which could be then heated to melt. Thereafter, the other cheeses whole milk Mozzarella cheese and Provolone Dolce cheese are added to the baked product and which could be again baked for predetermined amount of time to get the pizza product.

In another embodiment, the pizza could comprise vegetable and/or meat products such as bacon, onion, green pepper, pepperoni, olives, mushrooms, sausage, garlic, pineapple, ham, salami, spinach, chicken, anchovies, etc.

In addition to the various objects and advantages of the present invention described with some degree of specificity above it should be obvious that additional objects and advantages of the present invention will become more readily apparent to those persons who are skilled in the relevant art from the following more detailed description of the invention.

### BRIEF DESCRIPTION OF THE DRAWINGS

To further clarify various aspects of some example embodiments of the present invention, a more particular description of the invention will be rendered by reference to specific embodiments thereof, which are illustrated in the appended drawing. It is appreciated that the drawing depicts only illustrated embodiments of the invention and are therefore not to be considered limiting of its scope. The invention will be described and explained with additional specificity and detail with the use of the accompanying drawing in which:

FIG. 1A shows the initial step in making the pizza product, which includes the use of a cooking pan, olive oil and the prepared dough.

FIG. 1B is another step of the recipe showing the dough pressed into a cooking rectangular pan, as shown in FIG. 1A.

FIG. 1C shows the sauce brushed to the dough base of FIG. 1B

FIG. 1D shows the step of adding grated cheese to the dough base of FIG. 1C.

FIG. 1E shows dough base prepared as shown in FIG. 1D after first baking stage.

FIG. 1F shows addition of remaining cheeses to the semi-baked pizza product as shown in FIG. 1E.

FIG. 1G shows the addition of toppings to the semi-baked pizza product shown in FIG. 1F

FIG. 1H shows the pizza product obtained by baking the semi-baked pizza of FIG. 1G.

FIG. 1I shows the prepared pizza product in ready to eat form and cut into slices. FIG. 2 shows a variety of pizza obtained by the method of current invention.

### DETAIL DESCRIPTION OF THE INVENTION

The present invention provides a method to prepare a pizza product having a unique set of ingredients which provide a distinguish flavor and texture to the pizza product. Before explaining at least one embodiment of the invention in detail, it is to be understood that the invention is not limited in its application to the details of construction and the arrangements of the components set forth in the following description. The invention is capable of other embodiments and of being practiced and carried out in various ways. In addition, it is to be understood that the phraseology and terminology employed herein are for the purpose of description and should not be regarded as limiting.

As used in this specification and the appended claims, the singular forms “a”, “an”, and “the” include plural referents unless the content clearly dictates otherwise.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

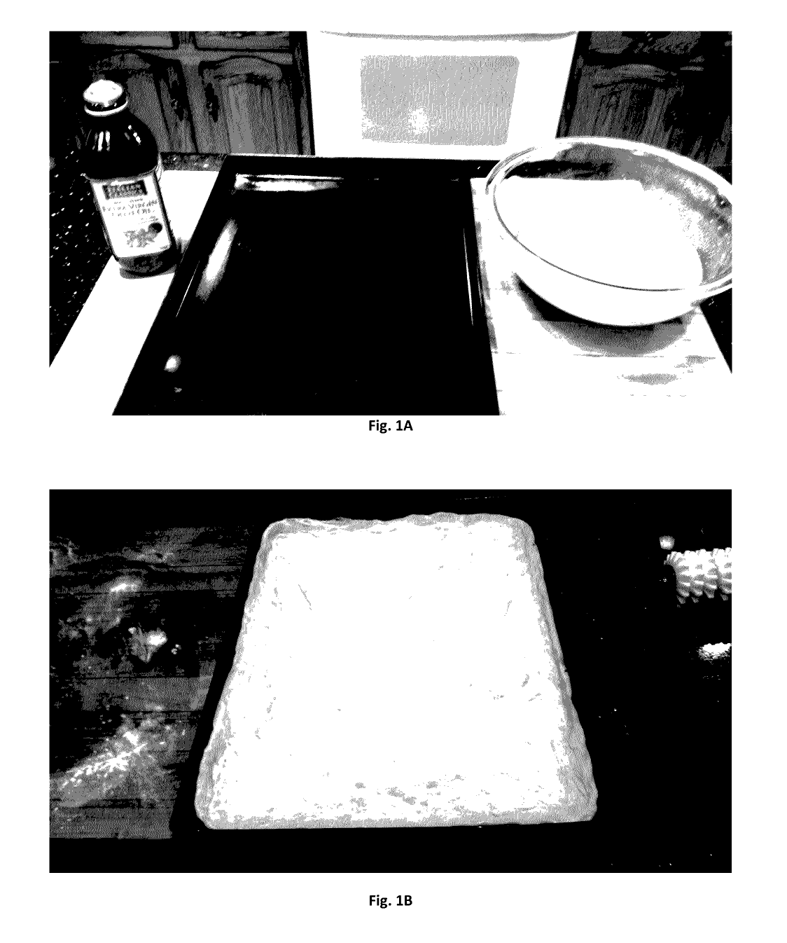

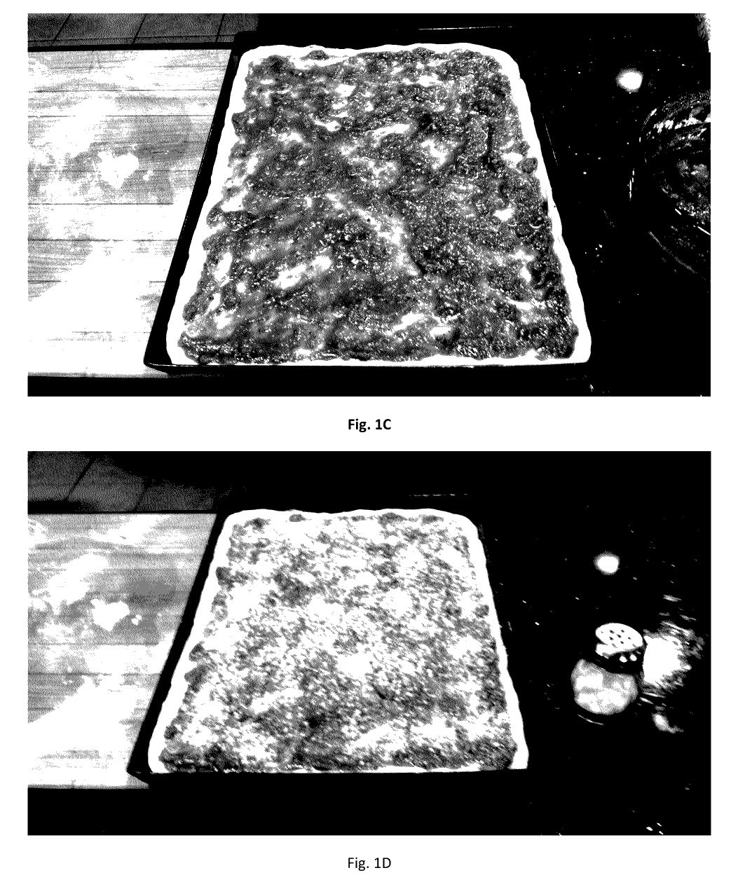

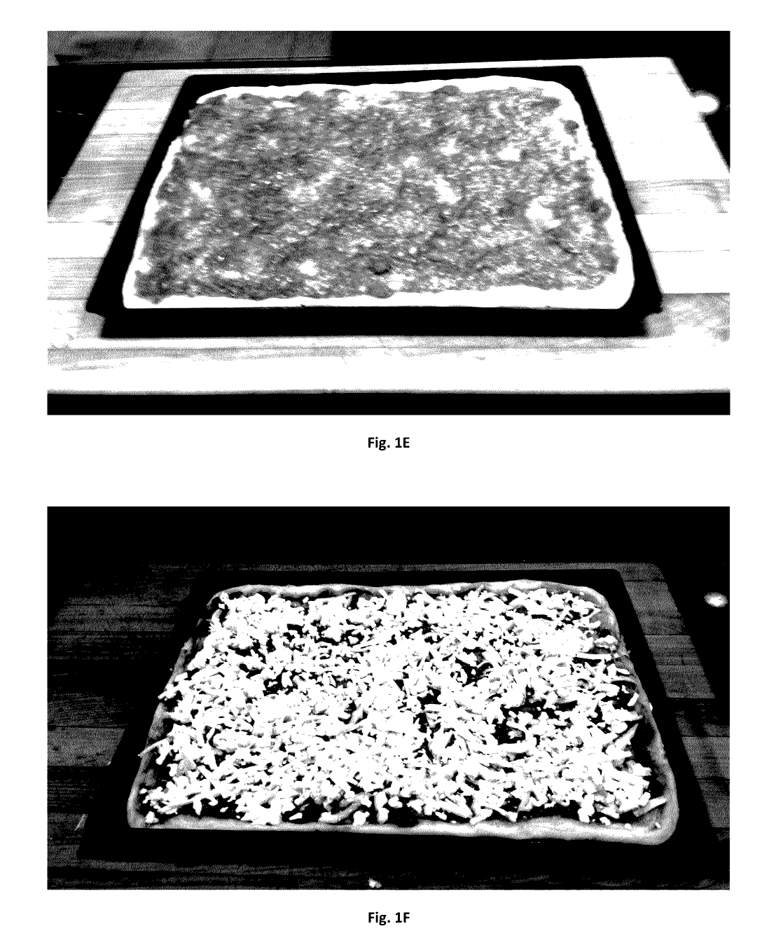

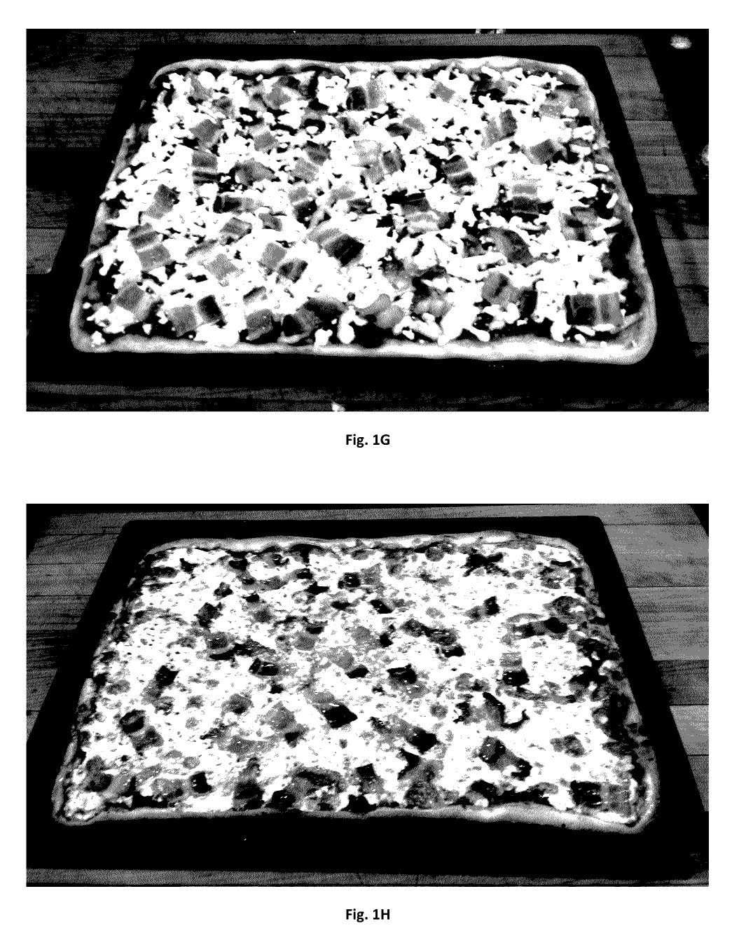

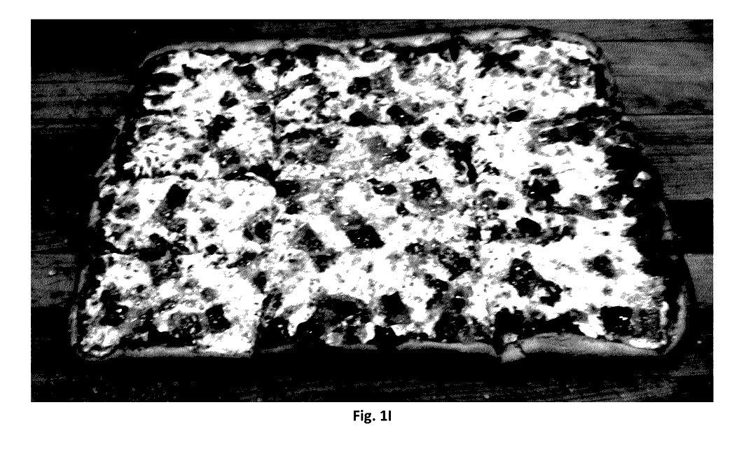

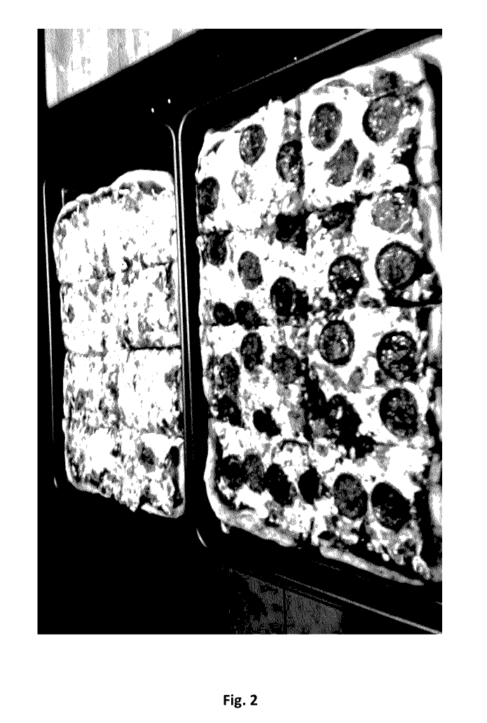

Referring to FIG. 1A-G, the present invention provides a method to prepare a pizza food product and the method is advantageous by including a unique set of ingredient and improved steps in preparing the pizza product resulting in a food product having a distinguish taste and an improved texture of the food product. The recipe of pizza product according to present invention includes a unique combination of cheeses that provides improved texture of the melted cheeses. The melted cheese is soft and remains consistent for long duration of time. The invention uses whole milk Mozzarella cheese, which provides soft texture cheese on melting, and has a distinct flavor. The other cheese used in the invention is Argentine Sardo cheese that is a hard to melt cheese and have a distinct flavor. It is made from cows milk and have been used in pasta, soups etc.

The combination of cheeses used in the invention i.e. whole milk Mozzarella cheese, Provolone Dolce cheese, Argentine Sardo cheese, and Pecorino Romano cheese have different melting properties wherein Argentine Sardo cheese, and Pecorino Romano cheese are hard to melt while whole milk Mozzarella cheese and Provolone Dolce cheese are soft cheeses. Adding all the chesses together may require longer heating time to melt the hard cheeses; however, the longer heating time may lead to overheating of the soft cheeses, which in turn may affect the taste, and consistency of the melted cheese combination. Thus, it was advantageous to bake the hard melt cheeses for pre-determined duration of time and then adding the soft cheeses, which could thereafter easily melt by heating for a shorter duration of time. The method of twice baking has a further advantage of making a crispier pizza bases without any blackening of the cheeses due to overheating.

The pizza product is prepared in multiple steps including preparing the dough; leavening the prepared dough using a leavening agent; preparing the sauces, preparing the toppings, preparing the cheeses and baking steps. Firstly, the required size of the pizza product is determined and the quantity of ingredients could be then determined accordingly to the size of pizza product. It is obvious that the pizza product could be made in variety of shaped such as square to rectangular, or a round to elliptical shape, moreover the edges of the pizza product could be smoothed or wavy. Depending upon the shape of pizza product the cooking utensil could be chosen such as for a rectangular shape pizza, a rectangular pan/tray could be used. Beside the cooking pan, the method may also require another cooking utensils and apparatus such as a bowl to prepare the dough or sauce, a mixer/grinder for mixing or kneading the flour, a grater to grate the cheese and an oven for use in baking the pizza product. The oven used in the invention could be a home use oven or a commercial oven; preferably, the oven should support temperature of 350 degree Celsius and above. It is preferable to use skillet steel pans such as commercially available hand-forged blue steel pans. However, other ordinary cooking pans, such as those made of aluminum or Teflon could also be use.

The step of preparing the dough base included preparing the dough and the prepared dough could be then fermented using the cold rise technique. The dough could be prepared from all-purpose flour or any specific variety of the flour could also be use. It is obvious that using different variety of flours may cause change in texture of the dough/pizza base. It is preferable to use high gluten flour, which improves the texture of dough and could be easy to mold into desired shape.

The other ingredients in preparing the dough base include water, yeast, edible salt, and oil. Although, the ingredients could be mixed in any obvious order to make the dough base. The preferably step to make the dough base includes adding the yeast to warm water with stirring and the mixture could be allowed to stand for predetermined amount of time, wherein frothing could be seen; then adding the predetermined amount of flour followed by adding the pre-determined amount of edible salt and oil. Further, it is obvious that any edible oil, such as coconut oil, olive oil etc. could be use but it is preferable to use the olive oil. Moreover, the dough could be prepared in a mixer or could be hand made by kneading. The prepared dough could be then leavened using yeast. Formulating yeast leavened dough is well known in the baking art and it is obvious to add yeast to warm water sufficient to activate the yeast, about 80-100° F. When using dry yeast, it is common practice to hydrate the yeast in water having an elevated temperature of up to about 150° F. for purposes of activating the yeast. It is preferable to use cold-rise technique wherein the kneaded dough is add to a previously greased bowl and some oil could be brushed to the kneaded dough, which could be then wrapped in a plastic sheet and kept in refrigerator for cold rise.

Another step in preparing the pizza product includes preparing the sauces; the sauces could be a tomato sauce with ingredients selected from crushed tomato, tomato puree, water, edible salt, dry oregano, and olive oil. The sauce could be prepared by stirring the entire ingredient together to obtain even slurry, which could be use directly in the recipe or could be stored in refrigerator until usage.

The next step in preparing the pizza includes preparing the pizza base wherein the leavened dough at room temperature is molded into a pan which is previously greased, by pressing and stretching the dough to form a plain dough base. The pan could be greased using olive oil and the greasing of pan is advantageous by allowing the underside of the dough to develop a crisp, lightly fried, or golden patterned base similar to that of a pan-baked restaurant product. The greater degree of oiling also prevents the base tasting dry following reheating. Thereafter the top surface of the dough base is brush with the sauces prepared as described above. Sauce is evenly spread to the dough base and then the grated cheeses could be added. In addition, any topping could be added with the grated cheeses. It is obvious to add varieties of vegetables and/or meat to the pizza product to obtain pizzas having variety of taste and nutritional value. Topping could include, but not limited to bacon, onion, green pepper, pepperoni, olives, mushrooms, sausage, garlic, pineapple, ham, salami, spinach, chicken, anchovies, etc. Furthermore, it is obvious to add a single or combination of toppings to the pizza product, such as a combination of onions and mushrooms. The pizza base with sauce, cheese, and toppings evenly spread could be baked in an oven at predetermined temperature range and for predetermined duration of time. Although it is obvious that the temperature and duration of heating should be sufficient to bake the pizza, the temperature could and time could be varied depending upon the ingredients. The remaining cheeses could then be added to semi-baked pizza product and heated again in the oven of pre-determined temperature and duration of time to melt the cheeses and make the pizza base crispier.

It is to be understood that the method to prepare the pizza product and ingredients of the pizza product encompasses a variety of alternatives. For example, the size and shape of pizza product could be varied. The quantity and nature of flour could be varied, for example, the pizza base could be made thin or thick. The temperature and duration of heating could varied to make the pizza chewy or crispy. Moreover, the proportion and amount of cheeses could be varied; also, the amount of salt added could vary according to the taste of the user. Certain ingredients could be replaced or may be left out, for example in preparation of sauces, the dry oregano may not be required. Similarly, different oils may be used wherein some oil may be preferably while other should not be used, for example, olive oil is preferably used in the invention while the peanut oil should not be used. Also the thickness of the dough base could be varied wherein some people may prefer a thin base while others may prefer thicker base. In addition, it is obvious that the various steps in making the pizza product could be carried in any order provided the taste and texture of final pizza product is not affected.

### BEST MODE OF CARRYING OUT THE INVENTION

Preparing the dough

| | |
|---|---|
| Water | 6.2 oz., |
| edible salt | 6.24 grams (Kosher Salt), |
| yeast - | 5 grams fresh active yeast, |
| all-purpose flour | 9.9 oz. high gluten flour, |
| oil - | 9.35 grams virgin olive oil. |

To a mixing bowl, containing preheated water at 80-90° F. is added fresh active yeast with stirring, and the stirred mixture is kept to stand for 10 min. Next, add the flour to the yeast and water mixture in the mixing bowl, then sprinkle the edible salt on top of the flour. Mix on low speed for 4 to 6 turns and slowly add the olive oil and mix at medium speed. Once the dough has solidified into a semi solid ball form, (this takes approximately 3-5 minutes), turn off mixer, and let the dough ball “rest” for 5 minutes. After the rest period, resume mixing at a medium to fast speed for 10 more minutes. Remove the formed dough ball form the mixer and shape and smooth the dough using hands, then brush the dough with small amount of oil and next place the dough ball in a pre-greased bowl and cover the bowl with plastic wrap. Now place the bowl in refrigerator for 24 hours to cold rise.

### Preparing the Pizza Sauce Prepping

| | | |
|---|---|---|
| crushed tomatoes | 28 | oz. |
| tomato puree | 14 | oz. |
| water | 6.2 | oz. |
| virgin olive oil | 16.9 | grams |
| kosher Salt | 11.1 | grams |
| dry oregano | 3.8 | grams |

Mix all ingredients together to obtain slurry, which could be used directly in recipe and could be refrigerated until needed.

Preparing the cheese prepping

| | |
|---|---|
| whole milk Mozzarella cheese | 16 oz. |
| Provolone Dolce cheese | 8 oz. |
| Argentine Sardo cheese | 30 grams |
| Pecorino Romano cheese | 30 grams |

Grate the whole milk Mozzarella cheese and Provolone Dolce cheese in shredded form and combine the two grated cheese, and then store in a container. The container could be kept in the refrigerator until for use in recipe. Finely grate the Argentine Sardo cheese and Pecorino Romano cheese, and combine the grated cheeses, which could be store in cheese shaker. Keep refrigerated until ready for use.

### Preparation of Pizza

| | |
|---|---|
| Prepared dough | 1 lb. (0.5 oz., 467 gm), |
| prepared sauce | 264 grams |
| Argentine Sardo cheese | 16 grams |
| Pecorino Romano cheese | 10 grams (combined with |
| | Argentine Sardo cheese) |
| whole milk Mozzarella cheese and | 230 grams |
| Pecorino Romano cheese mix | |
| Bacon toppings | as required. |

Preheat oven at 450 C. Degrees, and the dough ball which was stored in the refrigerator is taken out and brought to room temperature for about 30 minutes before preparing pizza. As shown in FIG. 1A, the pan surface is lightly oiled using olive oil. With slightly oiled hands, remove dough ball from bowl and using hands rotate and stretch the dough ball. Start to rotate and stretch, working from the edges while rotating. Dough should start to form a rectangle while stretching. Place dough in the lightly oiled blue steel pan, and thereafter using hands, press the dough to reach all four sides of the pan to get an even top surface as shown in FIG. 1B.

If any bubbling occurs after the first cooking, just puncture the bubble with a fork to release air bubble(s). Next, shown in FIG. 1C, ladle the sauce onto the dough base, spread the sauce, and be sure to bring the sauce very close to the edge of the crust. It is best not to put the sauce on too heavily. Then, as shown in FIG. 1D, dust the sauce with the Argentine Sardo cheese and Pecorino Romano cheese mixture that has been stored in a cheese shaker, evenly spread the cheese (Use about 16 grams, saving the rest (10 grams) for the finished product). Thereafter, bake the dough base in a preheated oven for 7 minutes at 450 degrees, the baked pizza should look like the pizza shown in FIG. 1E.

After baking the dough base, remove it from the oven, and evenly spread the Mozzarella cheese and Provolone Dolce cheese mixture as shown in FIG. 1F and, further add bacon pieces as shown in FIG. 1G. Return the semi-baked pizza to oven for an additional 7 to 9 minutes. Cheeses should be bubbling when fully cooked. The final pizza should like as shown in FIG. 1H.

Remove the pizza from pan, and let Pizza “rest” for 30 seconds to a minute before cutting. Use a pizza wheel to cut the pizza in desired shape like the one shown in FIG. 1I. Thereafter, dust with remaining amount of Argentine Sardo cheese and Pecorino Romano cheese mixture. FIG. 2 shows the final pizzas product having toppings.

Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

We claim:

26. A method for preparing a pizza food product, wherein said method comprising:
f. step of preparing a dough by adding yeast to a preheated water with stirring and allowing the mixture to stand for a predetermined duration of time, thereafter adding predetermined amount of all-purpose flour and an edible salt with stirring, followed by adding predetermined amount of an oil, kneading the mixture to form a semi-solid dough, leavening the said dough comprising greasing the dough with the oil, wrapping the greased dough in a plastic wrap, and placing the wrapped dough in a refrigerator for cold rise;
g. step of preparing a sauce using ingredients selected from a crushed tomatoes, a tomato puree, the water, the oil, and the edible salt, said ingredients are mixed to form a slurry;
h. step of preparing dough base by removing the leavened dough from refrigerator, said leavened dough is allowed to warm to room temperature, preparing the dough base by molding the leavened dough into a previously greased pan;
i. step of preparing the semi-baked pizza by brushing the said dough base with said prepared sauce, then adding a grated Argentine Sardo cheese and a Pecorino Romano cheese on top surface of the dough base, and thereafter, baking the dough base in a preheated oven and heating the dough base at predetermined temperature and duration of time to obtain semi-baked pizza; and
j. step of preparing the pizza product comprising adding whole milk Mozzarella cheese and Provolone cheese to the obtained semi-baked pizza, then heating the semi-baked pizza in an oven for predetermined temperature and duration of time to obtain said pizza product.

27. The method of preparing the pizza food product according to claim 1, wherein said step of preparing dough comprises adding salt to the yeast and water mixture, and thereafter adding all-purpose flour, edible salt and oil.

28. The method of preparing the pizza food product according to claim 1, wherein said step of preparing the pizza product further comprise adding of vegetables and meat to the dough base.

29. The method of preparing the pizza food product according to claim 1, wherein said pan is round in shape and said pizza is obtained in round shape.

30. The method of preparing the pizza food product according to claim 1, wherein said pan is rectangular in shape and said pizza is obtained in rectangular shape.

31. The method of preparing the pizza food product according to claim 1, wherein said all-purpose flour is a high gluten flour.

32. The method of preparing the pizza food product according to claim 1, wherein oil is an olive oil.

33. The method of preparing the pizza food product according to claim 1, wherein olive oil is used for greasing.

34. The method of preparing the pizza food product according to claim 1, wherein said step of preparing the sauce further comprise dry oregano.

35. The method of preparing the pizza food product according to claim 1, wherein said predetermined temperature and duration of time in the step of preparing the pizza product is 7 minutes at 450 degrees Celsius.

36. A pizza food product comprising:
e. a dough, prepared form all-purpose flour, water, edible salt, yeast, and vegetable oil;
f. a sauce prepared from crushed tomatoes, tomato puree, water, vegetable oil, and edible salt, said sauce applied to top surface of said flattened dough base;
g. Argentine Sardo cheese and Pecorino Romano cheese added to said sauce layer and the said dough base is baked;
h. whole milk Mozzarella cheese, Provolone Dolce cheese and toppings added to the said baked dough base and then baked again.

37. The pizza food product of claim 11, wherein said topping is selected from bacon, onion, green pepper, pepperoni, olives, mushrooms, sausage, garlic, pineapple, ham, salami, spinach, chicken, anchovies.

38. The pizza food product of claim 11, wherein said all-purpose flour is a high gluten flour.

39. The pizza food product of claim 11, wherein said vegetable oil is an olive oil.

40. The food product of claim 11, wherein said sauce further comprise dry oregano.

41. The pizza food product of claim 11, wherein said Argentine Sardo cheese and Pecorino Romano cheese are added in grated form.

42. A pizza food product obtained by a method wherein said method comprising:
f. step of preparing a dough by adding yeast to a preheated water with stirring and allowing the mixture to stand for a predetermined duration of time, thereafter adding predetermined amount of all-purpose flour with previously sprinkled edible salt, followed by adding predetermined amount of an oil, kneading the mixture to form a semi-solid dough, leavening the said dough comprising greasing the dough with the oil, wrapping the greased dough in a plastic wrap, and placing the wrapped dough in a refrigerator for cold rise;
g. step of preparing a sauce using ingredients selected from a crushed tomatoes, a tomato puree, the water, the oil, and the edible salt, said ingredients are mixed to form a slurry;
h. step of preparing dough base by removing the leavened dough from refrigerator, said leavened dough is allowed to warm to room temperature, preparing the dough base by molding the leavened dough into a previously greased pan;
i. step of preparing the semi-baked pizza by brushing the said dough base with said prepared sauce, then adding a grated Argentine Sardo cheese and a Pecorino Romano cheese on top surface of the dough base, and thereafter, baking the dough base in a preheated oven and heating the dough base at predetermined temperature and duration of time to obtain semi-baked pizza; and
j. step of preparing the pizza product comprising adding whole milk Mozzarella cheese and Provolone cheese to the obtained semi-baked pizza, then heating the semi-baked pizza in an oven for predetermined temperature and duration of time to obtain said pizza product.

43. The pizza food product according to claim 17, wherein said step of preparing the semi-baked pizza further comprise adding of vegetables and meat to the dough base.

44. The pizza food product according to claim 17, wherein said all-purpose flour is a high gluten flour.

45. The pizza food product according to claim 17, wherein oil is an olive oil.

46. The pizza food product according to claim 17, wherein olive oil is used for greasing.

47. The pizza food product according to claim 17, wherein said step of preparing the sauce further comprise dry oregano.

48. The pizza food product according to claim 17, wherein said predetermined temperature and duration of time in the step of preparing the pizza product is 7 minutes at 450 degrees Celsius.

49. The pizza food product according to claim 17, wherein said pizza food product is round shape.

50. The pizza food product according to claim 17, wherein said pizza food product is rectangular shape.
